(19) United States
(12) Patent Application Publication
(10) Pub. No.: US 2020/0164806 A1
(43) Pub. Date: May 28, 2020

(54) Emerging Side/Rear View Mirror Apparatus

(71) Applicant: Andre Salaam, Irvington, NJ (US)

(72) Inventor: Andre Salaam, Irvington, NJ (US)

(21) Appl. No.: 16/696,398

(22) Filed: Nov. 26, 2019

Related U.S. Application Data
(60) Provisional application No. 62/771,253, filed on Nov. 26, 2018.

(51) Int. Cl. B60R 1/07; B60R 1/12; B60R 1/00

(52) U.S. Cl. CPC B60R 1/07; B60R 2001/1223; B60R 1/006; B60R 1/12

(57) ABSTRACT

An emerging side view mirror apparatus used in concealing a rear-view side mirror within a vehicle is provided. The apparatus provides concealment for the mirror within a vehicle, such that the concealed mirror is protected from glancing blows from passing/parking vehicles. The apparatus is positioned within a housing which comprises a mirror cavity portion and a mirror opening. The mirror cavity portion serves as the spatial clearance in which the mirror can be concealed. The mirror channel serves as an access opening that allows the mirror to deploy to a deployed mirror position along the door panel. The track is positioned within the mirror cavity portion and the mirror opening, serving as guiderails. The shuttle slidably engages the track with the mirror connected to the shuttle. The power supply and power source then operate the shuttle, moving the mirror between a retracted or a deployed position.

The current application claims a priority to the U.S. Provisional Patent application Ser. No. 62/771,253 filed on Nov. 26, 2018.

### FIELD OF THE INVENTION

The present invention relates to automobile mirrors; more particularly, the present invention relates to a side view mirror that can be selectably deployed from or concealed within a vehicle body.

### BACKGROUND OF THE INVENTION

Vehicle rear side view mirrors are subjected to damage in urban environments with narrow streets and parking lots. When a driver maneuvers their car in reverse too close to another car, they may unwittingly fail to account for their vehicle's blind spots, oftentimes swiping the vehicle mirror of a parked car before making contact with any other part of the parked vehicle. Additionally, urban environments with narrow streets often pose a risk for vehicles parked on the sides of the streets. Passing vehicles may veer too close to the parked vehicle, and swipe the parked vehicle rear side view mirror, resulting in costly damages. Some vehicle side mirrors, and housings have been designed to fold inward, either manually or mechanically, or to telescopically deploy outward. A major drawback for the proposed designs is that they are still exposed to the outside vehicle panel, and therefore can still be damaged by passing vehicles.

The present invention aims to address these problems. The present invention features a robotically motorized means of completely concealing the rear side view mirror within the vehicle door panel and fender sections. The present invention features a processing unit that integrates the apparatus to the vehicle on-board computer, facilitating manual and autonomous controlling means in deploying or retracting the rear side view mirror within the vehicle door panel and fender sections. The present invention features a robotically motorized hatch that shrouds and secures a mirror opening, preventing dust, water, or debris from intruding into the interior section that the mirror is concealed in. Furthermore, the present invention features a plurality of optical sensors, facilitating autonomous angle and linear positioning of the mirror along the door panel exterior when deployed.

### SUMMARY OF THE INVENTION

The present invention is an emerging side view mirror apparatus that allows the driver to retract or deploy a rear side view mirror within a door panel and a fender portion of a vehicle. The emerging side/rear view mirror apparatus is installed on both the passenger side and the driver side portions of the vehicle. The emerging side/rear view mirror apparatus comprises a housing, a track, a carriage, a shuttle, a mirror, a processing unit, and a power source. The housing comprises a mirror cavity portion and a mirror opening. The mirror cavity portion is positioned to adjacent the interior space between the fender panel and the vehicle chassis frame. The mirror cavity serves as the spatial compartment for the mirror when the mirror is retracted. The mirror opening is positioned to the door panel, replacing the original placement of the rear-view side mirror.

The track is positioned within the mirror cavity portion and the mirror opening. Additionally, the track traverses from the mirror cavity portion to the mirror opening. The track may take the form of guide rods that facilitate the mounting of the shuttle. The shuttle is slidably engaged to the track, where the mirror is connected to the shuttle. The shuttle may take the form of an electronic actuating driver that drives the mirror along the track. The processing unit is operatively connected to the shuttle, where the processing unit is configured to move the shuttle along the track between a deployed position and a retracted position. The power source is electronically connected to the processing unit.

Furthermore, the processing unit is integrated to the vehicle on-board computer, specifically integrated to manual and autonomous controls of the vehicle, allowing the driver to manually control the retraction or deployment of the mirror, or automatically control the retraction/deployment of the mirror such that the mirrors retract when the vehicle is turned off and deploy when the vehicle is turned on.

### BRIEF DESCRIPTION OF THE DRAWINGS

FIG. 1 is a perspective view of the present invention.

FIG. 2 is a front perspective view of the present invention that is installed into a vehicle in its retracted position.

FIG. 3 is a rear perspective view of the present invention that is installed into a vehicle in its retracted position.

FIG. 4 is a rear perspective view of the present invention that shows a hatch mechanism opening a cover.

FIG. 5 is a rear perspective view of the present invention that is installed into a vehicle in its deployed position.

FIG. 6 is a diagram of the present invention that shows the electronic components used in the present invention.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

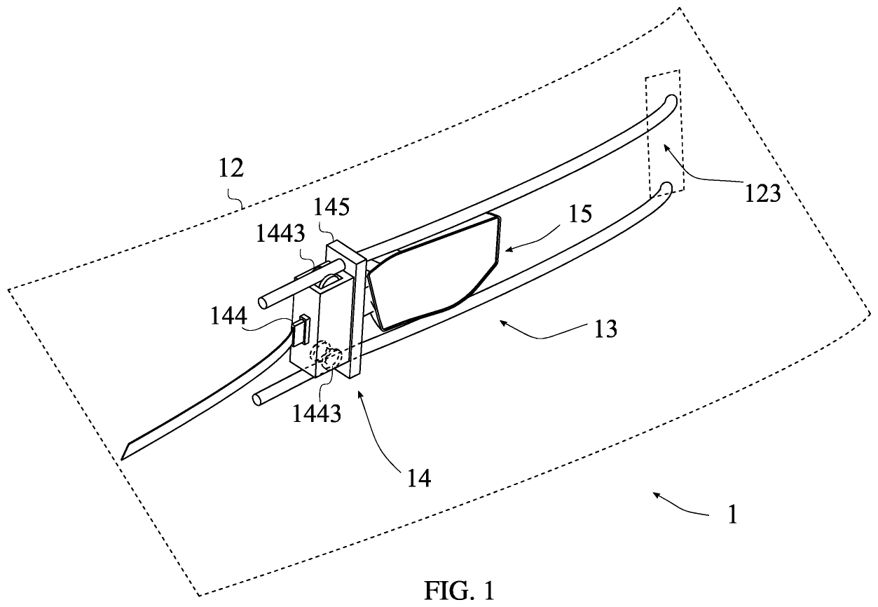

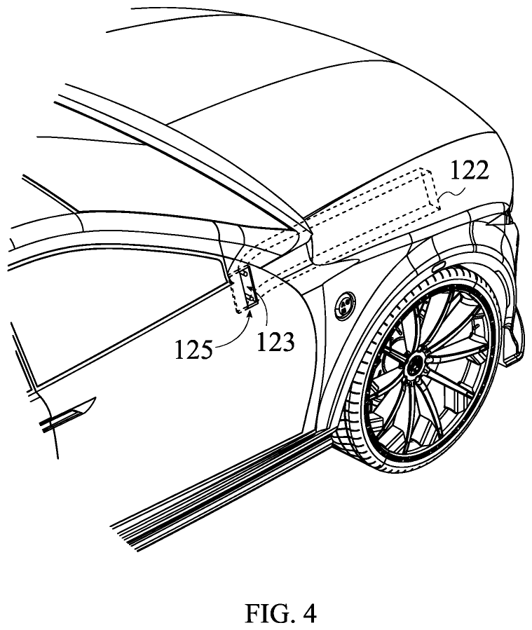

In reference to FIGS. 1-5, the present invention is an emerging side/rear view mirror apparatus 1 that allows the driver to retract and conceal a rear side view mirror 15 within a door panel and a fender portion of a vehicle. This concealment of the rear side view mirror 15 within the door panel and the fender portion of the vehicle protects the rear side view mirror 15 from subsequent damage when the vehicle is parked. Additionally, the emerging side/rear view mirror apparatus 1 allows the user to deploy the rear side view mirror 15 out of the door panel and the fender portion, positioning the rear side view mirror 15 out for use. In the preferred embodiment of the present invention, the emerging side/rear view mirror apparatus 1 allows the driver to partially deploy the rear side view mirror 15, facilitating a narrow side rear view mirror 15 profile suitable for narrow streets and confined spaces. In various embodiments of the present invention, the emerging side/rear view mirror apparatus 1 can be integrated in various type of vehicle platforms such as but not limited to cars, trucks, motorcycles, boats, scooters, or any other suitable vehicle.

In reference to FIGS. 1-6, the emerging side/rear view mirror apparatus 1 comprises a housing 12, a track 13, a carriage 145, a shuttle 14, the mirror 15, a processing unit 16, and a power source 17. In the preferred embodiment of the present invention, the emerging side/rear view mirror apparatus 1 is installed in both the passenger side and the driver side portions of the vehicle. The rear side view mirror 15, or mirror 15 for short, resides in the housing 12. The housing 12 comprises a mirror cavity portion 122 and a mirror opening 123. The housing 12 is positioned within the door panel and the fender portion of the vehicle. In the preferred embodiment of the present invention, the housing 12 may take the form of the internal spatial clearance between the vehicle chassis frame and the vehicle exterior panels. The mirror cavity 112 is positioned along the fender portion of the vehicle. In the preferred embodiment of the present invention, the mirror cavity portion 122 is positioned adjacent to the mirror opening 123. The mirror cavity 112 may take the form of the space between the fender panel exterior and the vehicle chassis frame that facilitates the concealment of the side rear view mirror 15 when the emerging side/rear view mirror 15 is configured to its retracted configuration. In the preferred embodiment of the present invention, the mirror opening 123 is positioned adjacent to the door panel exterior portion of the vehicle where the rear-view side mirror 15 typically resides. The mirror opening 123 may take the form of an access opening, allowing the mirror 15 to emerge out of the door panel exterior when the emerging side/rear view mirror apparatus 1 is in its deployed configuration.

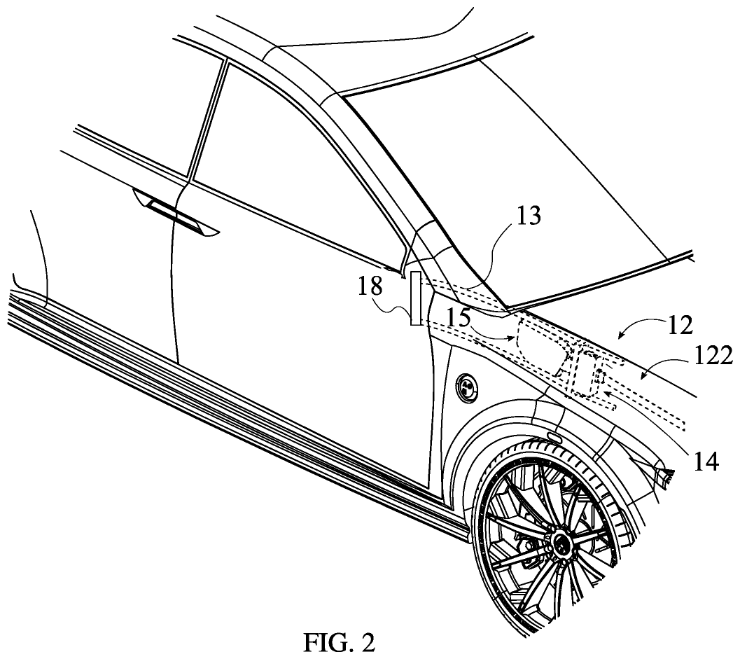

In reference to FIGS. 1-2, the track 13 is positioned within the mirror cavity portion 122 and the mirror opening 123. The track 13 traverses the mirror cavity portion 122 to the mirror opening 123. In the preferred embodiment of the present invention, the track 13 may take the form of guiderails that guides the concealed mirror 15 from the mirror cavity portion 122 to the mirror opening 123. In the preferred embodiment of the present invention, the track 13 may take the form of curved guide rods that allows the mirror 15 to traverse through the mirror cavity portion 122 to the mirror opening 123. In various embodiments of the present invention, the track 13 may take the form of any suitable track 13 such as but not limited to guide rails, guide channels, gear racks, or any other suitable means to provide passage for the mirror 15 to traverse from the mirror cavity portion 122 to the mirror opening 123.

In reference to FIGS. 1-2, the shuttle 14 is slidably engaged to the track 13. Additionally, the mirror 15 is connected adjacent to the shuttle 14. In the preferred embodiment of the present invention, the shuttle 14 may take the form of a movable robotic transportation member that moves the mirror 15 along the track 13. In various embodiments of the present invention, the shuttle 14 may take the form of any type of suitable transport member that can be powered through mechanical, electronic, pneumatic, or hydraulic means.

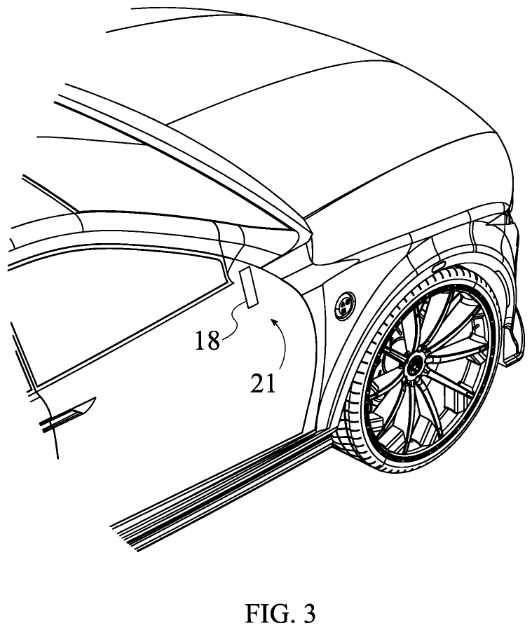

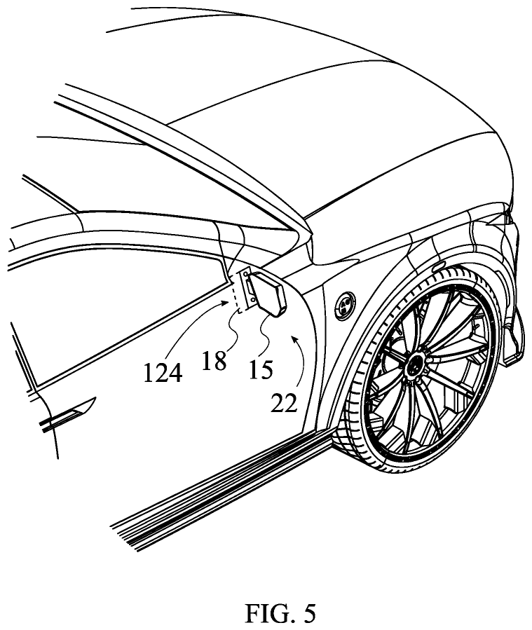

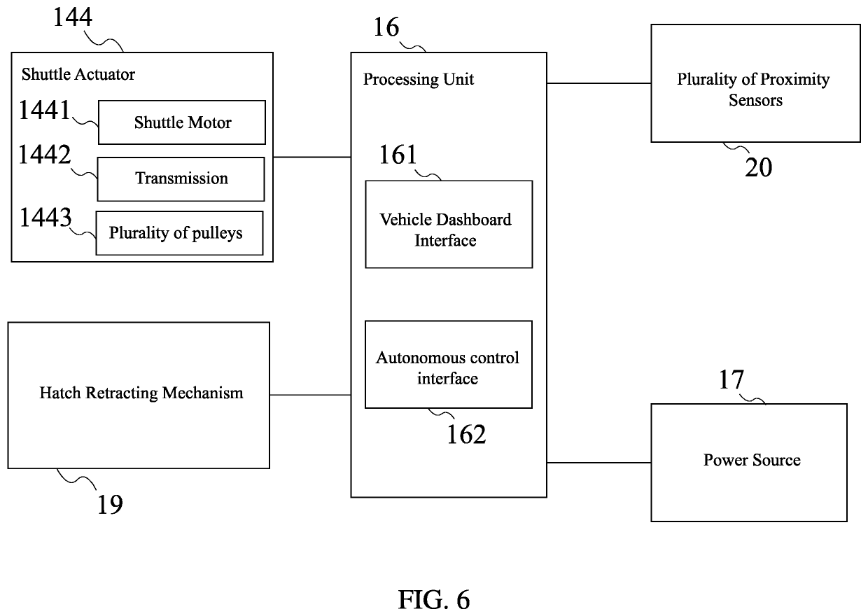

In reference to FIG. 6, the processing unit 16 is operatively connected to the shuttle 14, where the processing unit 16 is configured to move the shuttle 14 along the track 13 between a retracted position 21 and a deployed position 22, as seen in FIGS. 3 and 5. In the preferred embodiment of the present invention, the processing unit 16 may take the form of a control board that is integrated to the vehicle on-board computer, facilitating manual and autonomous control of the shuttle 14. In one embodiment, the processing unit 16 is electronically connected to the vehicle manual control dashboard, where the user can manually retract/deploy the mirror 15 through a switch, dial, slider, voice command, or any other suitable manual adjuster. In another embodiment of the present invention, the processing unit 16 is electronically connected to the vehicle autonomous control module, where the manipulation of the mirror 15 in its retracted/deployed configuration is done autonomously such that the mirror 15 automatically deployed when the vehicle is started, and retracts when the vehicle is turned off.

In reference to FIG. 6, the power source 17 is electronically connected to the processing unit 16. In the preferred embodiment of the present invention, the power source 17 may take the form of an electrical power source 17, powering the electronic shuttle 14. In one embodiment, the power source 17 may take the form of the vehicle battery power supply. In various embodiments of the present invention, the power source 17 may take the form of any type of power source 17 such as, but not limited to mechanical, pneumatic, or hydraulically sourced power sources.

In reference to FIGS. 1-5, the emerging side/rear view mirror apparatus 1 further comprises a cover 18 and a hatch retracting mechanism 19. The housing 12 further comprises a hatch cavity portion 124 and a hatch frame 125. The hatch frame 125 is terminally positioned adjacent to the mirror opening 123 and traverses across the hatch cavity portion 124. In the preferred embodiment of the present invention, the hatch cavity portion 124 may take the form of the spatial clearance adjacent to the mirror opening 123, facilitating the cover 18 to conceal along the hatch cavity portion 124. In the preferred embodiment of the present invention, the hatch frame 125 may take the form of a guiderail platform for the cover 18. The cover 18 is slidably engaged to the hatch frame 125. The cover 18 may take the form of a movable vehicle body panel exterior that shrouds the mirror opening 123 when the mirror 15 is retracted. The hatch retracting mechanism 19 is operatively connected to the cover 18. In the preferred embodiment of the present invention, the hatch retracting mechanism 19 may take the form of an electronically driven linear actuator but can be any suitable type of actuator. In the preferred embodiment of the present invention, the hatch retracting mechanism 19 is operatively connected to the processing unit 16, where the processing unit 16 is configured to move the cover 18 along the hatch frame 125 between an open position and a closed position. When the mirror 15 is being deployed, the hatch retracting mechanism 19 slides the cover 18 to the hatch cavity portion 124, revealing the mirror opening 123 to allow the deployed mirror 15 to position along the mirror opening 123 end. When the mirror 15 is being retracted, the hatch retracting mechanism 19 slides the cover 18 to the mirror opening 123, closing off the mirror opening 123 to disallow dirt and debris from traversing through the exposed mirror opening 123.

In reference to FIG. 6, the emerging side/rear view mirror apparatus 1 further comprises a plurality of proximity sensors 20. The plurality of proximity sensors 20 is positioned adjacent to the mirror 15. The plurality of proximity sensors 20 is electronically connected to the processing unit 16. In the preferred embodiment of the present invention, the plurality of proximity sensors 20 may take the form of a series of optical sensors that allows the mirror 15 in its deployed configuration to send proximity feedback of the driver's head and the mirror 15 to the processor which will then automatically adjust to an optimal rear side view mirror 15 position that gives the driver the best sight angle when the driver is looking through the rear side view mirror 15. In the preferred embodiment of the present invention, the plurality of proximity sensors 20 may also take the form of optical sensors that can automatically retract the mirror 15 to a narrower length suited for narrow roads and confined spaces.

In reference to FIG. 2, the shuttle 14 comprises a shuttle actuator 144 and a carriage 145. The shuttle actuator 144 is connected to the carriage 145. In the preferred embodiment of the present invention, the shuttle actuator 144 may take the form of an electronically driven actuator that allows the mirror 15 to move along the track 13 in its retracted and deployed configuration. The carriage 145 is slidably engaged to the track 13. Additionally, the mirror 15 is connected to the carriage 145 opposite to the shuttle actuator 144 side. In the preferred embodiment of the present invention, the carriage 145 may take the form of a connection bracket that secures the mirror 15 and the shuttle actuator 144 together along the track 13.

In reference to FIGS. 2, and 6, the shuttle actuator 144 comprises a shuttle motor 1441, a transmission 1442, and a plurality of pulleys 1443. In the preferred embodiment of the present invention, the shuttle motor 1441 is electronically connected to the processing unit 16. The shuttle motor 1441 may take the form of an electronically driven servo or stepper motor. In various embodiments the shuttle motor 1441 may take the form of any other suitable driver such as but not limited to hydraulic, mechanical, pneumatic, or any other suitable motor driver means.

In reference to FIG. 6, the transmission 1442 is operatively connected to the shuttle motor 1441. The transmission 1442 may take the form of a gearbox drive system that converts the torque exerted from the motor to suitable torque output for the plurality of pulleys 1443. The plurality of pulleys 1443 is operatively connected to the transmission 1442. Additionally, each of the of pulleys is rotatably engaged with the track 13. In the preferred embodiment of the present invention, the plurality of pulleys 1443 may take the form of rolling casters that engage the track 13, facilitating the shuttle 14 to move along the track 13 when the plurality of pulleys 1443 is turned. In various embodiments of the present invention, the plurality of pulleys 1443 may take the form of gears, threaded rods, spindles, or any other suitable component that corresponds to the meshing with the track 13.

Although the invention has been explained in relation to its preferred embodiment, it is to be understood that many other possible modifications and variations can be made without departing from the spirit and scope of the invention as hereinafter claimed.

What is claimed is:

1. An emerging side/rear view mirror apparatus comprising:
a housing;
a track;
a shuttle;
a mirror
a processing unit;
a power source;
the housing comprising a mirror cavity portion, and a mirror opening;
the mirror cavity portion being positioned adjacent to the mirror opening;
the track being positioned within the mirror cavity portion and the mirror opening;
the track traversing from the mirror cavity portion to the mirror opening;
the shuttle being slidably engaged to the track;
the mirror being connected adjacent to the shuttle;
the processing unit being operatively connected to the shuttle, wherein the processing unit is configured to move the shuttle along the track between a deployed position and a retracted position; and
the power source being electronically connected to the processing unit.

2. The emerging side/rear view mirror apparatus as claimed in claim 1 comprising:
a cover;
a hatch retracting mechanism;
the housing further comprising a hatch cavity portion, and a hatch frame;
the hatch frame being terminally positioned adjacent to the mirror opening and traversing across the hatch cavity portion;
the cover being slidably engaged to the hatch frame;
the hatch retracting mechanism being operatively connected to the cover; and
the hatch retracting mechanism being operatively connected to the processing unit, wherein the processing unit is configured to move the cover along the hatch frame between an open position and a closed position.

3. The emerging side/rear view mirror apparatus as claimed in claim 1 comprising:
a plurality of proximity sensors;
the plurality of proximity sensors being positioned adjacent to the mirror; and
the plurality of proximity sensors being electronically connected to the processing unit.

4. The emerging side/rear view mirror apparatus as claimed in claim 1 comprising:
the shuttle comprising a shuttle actuator and a carriage;
the shuttle actuator being connected to the carriage;
the carriage being slidably engaged to the track; and
the mirror being connected to the carriage opposite to the shuttle actuator side.

5. The emerging side/rear view mirror apparatus as claimed in claim 4 comprising:
the shuttle actuator comprising a shuttle motor, a transmission, and a plurality of pulleys;
the shuttle motor being electronically connected to the processing unit;
the transmission being operatively connected to the shuttle motor;
the plurality of pulleys being operatively connected to the transmission; and
each of the of pulleys being rotatably engaged with the track.
